(19) United States
(12) Patent Application Publication
(10) Pub. No.: US 2014/0010476 A1
(43) Pub. Date: Jan. 9, 2014

(54) METHOD FOR FORMING PICTURES

(71) Applicants: Hui Deng, Hangzhou City (CN); Jin Wang, Hangzhou City (CN); Ji Lv, Hangzhou City (CN)

(72) Inventors: Hui Deng, Hangzhou City (CN); Jin Wang, Hangzhou City (CN); Ji Lv, Hangzhou City (CN)

(21) Appl. No.: 13/541,675

(22) Filed: Jul. 4, 2012

(51) Int. Cl. G06K 9/36

(52) U.S. Cl. 382/284

(57) ABSTRACT

Continuously capture an image to generate a plurality of frames. Arrange the plurality of frames in a matrix. Select a set of frames from the matrix. Process the set of frames with multi-frame processing algorithms to generate a plurality of processed frames, and form at least one enhanced picture from the plurality of processed frames.

### BACKGROUND OF THE INVENTION

1. Field of the Invention

The present invention is related to a method for forming pictures, and more particularly to a method that applies multi-frame processing algorithms to frames for forming enhanced pictures.

2. Description of the Prior Art

With the advancement of digital cameras, various shooting modes such as continuous shooting mode, close-up mode, night mode, portrait mode, landscape mode, etc. maybe selected to take pictures in different scenes. Further, values of shooting parameters such as shutter speed, sensor sensitivity (ISO), aperture, and exposure value (EV) may be adjusted by digital cameras automatically or by users manually according to various light conditions in order to capture better images.

However, there are technical limitations of digital cameras. For example, due to the limited depth of field of optical lenses, it is difficult to obtain a single picture with all objects in focus. Thus objects out of focus may be blurred in the picture. Sometimes even pictures taken with proper settings of mode and parameter values may not be colorful or bright enough without further processing.

### SUMMARY OF THE INVENTION

An embodiment of the present invention discloses a method for forming at least one picture. The method comprises continuously shooting an image to generate a plurality of frames, arranging the plurality of frames in a matrix, selecting a set of frames from the matrix, extracting portions of the set of frames, and combining the portions to form at least one picture.

Another embodiment of the present invention discloses a method for forming at least one picture. The method comprises continuously shooting an image to generate a plurality of frames, arranging the plurality of frames in a matrix, selecting a set of frames from the matrix, processing the set of frames with multi-frame processing algorithms to generate a plurality of processed frames, and forming at least one picture from the plurality of processed frames.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are flowcharts illustrating methods for forming enhanced pictures according to embodiments of the present invention.

FIG. 3 illustrates an embodiment of the method according to FIG. 1.

FIG. 4 illustrates another embodiment of the method according to FIG. 1.

FIG. 5 illustrates another embodiment of the method 100 according to FIG. 1.

FIG. 6 illustrates another embodiment of the method 200 according to FIG. 2.

FIG. 7 illustrates other embodiments of methods according to FIGS. 1 and 2.

### DETAILED DESCRIPTION

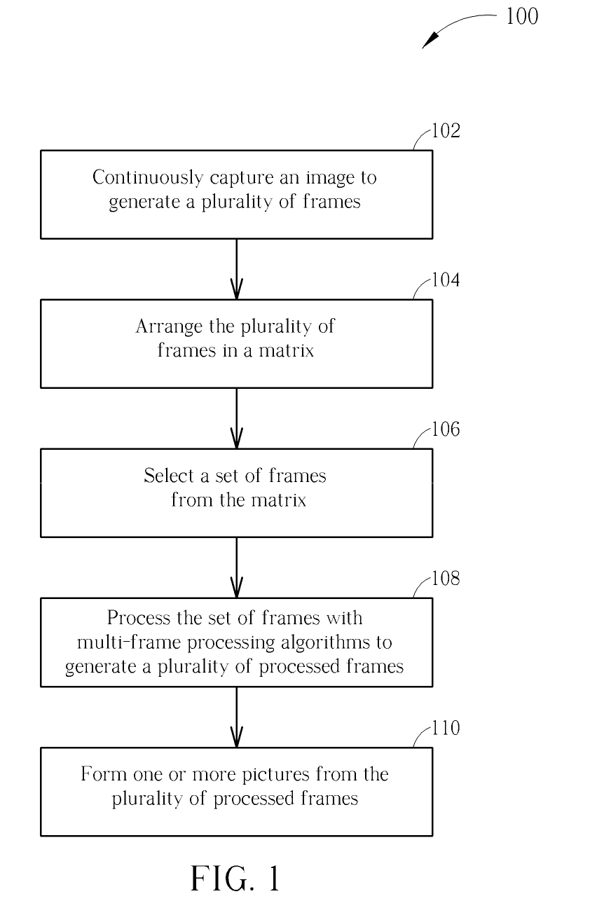

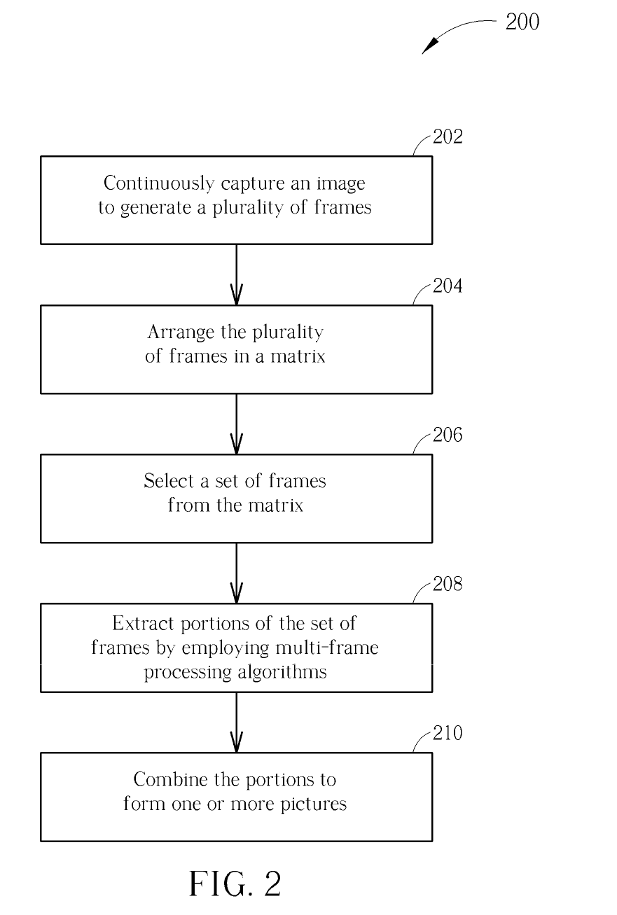

FIGS. 1 and 2 are flowcharts illustrating methods 100 and 200 for forming enhanced pictures according to embodiments of the present invention. Methods 100 and 200 may be performed in digital cameras or in electronic devices, such as smart phones, personal computers, and tablet computers equipped with digital cameras.

The method 100 may include the following steps:

Step 102: Continuously shoot an image to generate a plurality of frames;

Step 104: Arrange the plurality of frames in a matrix;

Step 106: Select a set of frames from the matrix;

Step 108: Process the set of frames with multi-frame processing algorithms to generate a plurality of processed frames;

Step 110: Form one or more pictures from the plurality of processed frames.

The method 200 may include the following steps:

Step 202: Continuously shoot an image to generate a plurality of frames;

Step 204: Arrange the plurality of frames in a matrix;

Step 206: Select a set of frames from the matrix;

Step 208: Extract portions of the set of frames by employing multi-frame processing algorithms;

Step 210: Combine the portions to form one or more pictures.

For all embodiments in the present invention, continuous shooting mode stands for capturing a sequence of photos of an image in rapid succession over a short period of time, and continuous shooting mode may be set while other modes are set, further “photo” and “frame” both means photograph and may be used interchangeably. In some embodiments, values of corresponding parameters such as shutter speed, sensor sensitivity (ISO), aperture, and exposure value (EV), etc. of the digital camera may remain the same when capturing the sequence of photos. In other embodiments, at least one parameter value of the digital camera may be changed when capturing different photos of the sequence of photos.

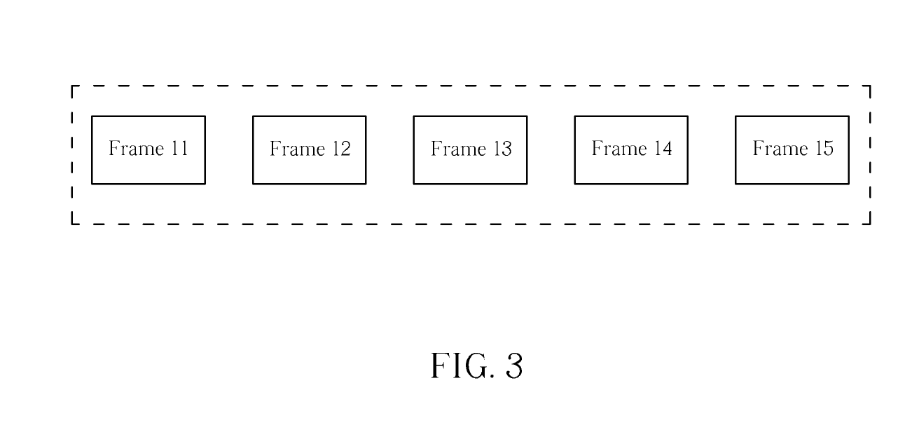

FIG. 3 illustrates an embodiment of the method 100 according to FIG. 1. The method 100 may be used for night shot enhancement in this embodiment. The digital camera may be set to shoot in both continuous shooting mode and night shot mode so as to capture a series of five photos of an image in a dark environment or in a night scene. All values of corresponding parameters may be set before shooting and remain the same when capturing the series of five photos in order to produce five identical photos. For example, ISO value and shutter speed value may be set to 400 and 1/45 respectively. Next, step 102 to 104 maybe performed to generate a matrix containing a row of five frames, which are frame 11, frame 12, frame 13, frame 14, and frame 15 in FIG. 3. Then, all of the five identical frames encompassed by a dashed line in FIG. 3 are selected and processed with multi-frame processing algorithms to generate five processed frames and combined to form a picture of a night scene with enhanced quality and brightness.

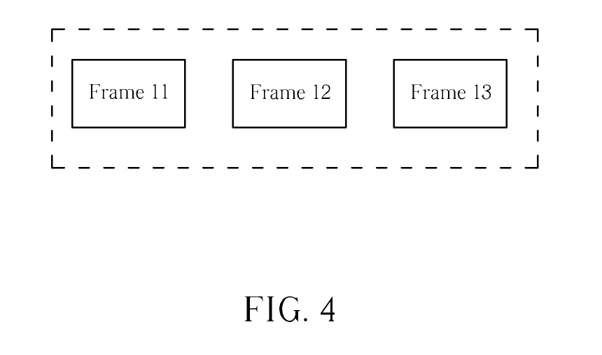

FIG. 4 illustrates another embodiment of the method 100 according to FIG. 1. The method 100 may be used for HDR (high dynamic range) enhancement in this embodiment. The digital camera maybe set to shoot in continuous shooting mode to capture a series of three photos from an image. Exposure value maybe set to EV+1 when capturing a first photo of the three photos, EV+0 when capturing a second photo of the three photos, and EV−1 when capturing a third photo of the three photos. Other values of corresponding parameters may remain the same when capturing the series of three photos. Next, step 102 to 104 maybe performed to generate a matrix containing a row of three frames, which are frame 11, frame 12, and frame 13 in FIG. 4. Then, all of the three frames encompassed by a dashed line in FIG. 4 are selected and processed with multi-frame processing algorithms to generate three processed frames and combined to form a picture. Because exposure values are changed when capturing the series of three photos, details and color restoration of each photo are different. By combining photos having different details and color restoration after processed with multi-frame processing algorithms, an enhanced high dynamic range picture may be formed.

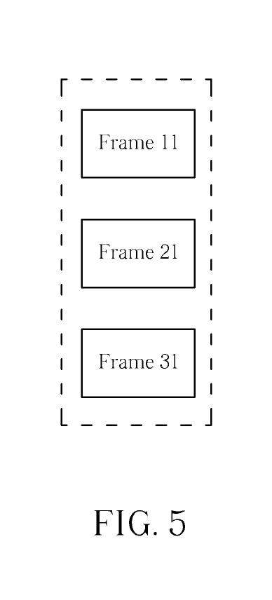

FIG. 5 illustrates another embodiment of the method 100 according to FIG. 1. The method 100 may be used for HDR (high dynamic range) enhancement in this embodiment by adjusting focal plane. The digital camera may be set to shoot in continuous shooting mode to capture a series of three photos of an image. Focal plane may be adjusted when capturing a first, a second, and a third of the three photos. The other values of corresponding parameters may remain the same when capturing the series of three photos. Next, step 102 to 104 maybe performed to generate a matrix containing a column of three frames, which are frame 11, frame 21, and frame 31 in FIG. 5. Then, all of the three frames encompassed by a dashed line in FIG. 5 are selected and processed with multi-frame processing algorithms to generate three processed frames and combined to form a picture. Because focal planes are adjusted when capturing the series of three photos, details and color restoration of each photo are different. By combining photos having different details and color restoration after processed with multi-frame processing algorithms, an enhanced high dynamic range picture may be formed.

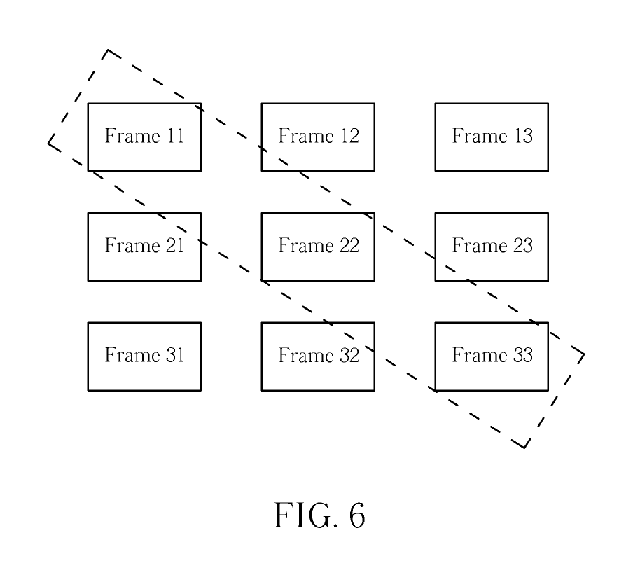

FIG. 6 illustrates another embodiment of the method 200 according to FIG. 2. The method 200 maybe used for EDOF (extend depth of field) enhancement in this embodiment. The digital camera may be set to shoot in continuous shooting mode to capture a series of nine photos of an image. Focal plane and value of another parameter (may be any parameter of the digital camera that can be set) maybe adjusted when capturing the series of nine photos. The other values of corresponding parameters may remain the same when capturing the series of nine photos. Next, step 202 to 204 may be performed to generate a 3*3 matrix containing frame 11 to frame 33 in FIG. 6. Frames in a first row (frame 11, frame 12, frame 13) have a first focal plane FP1, frames in a second row (frame 21, frame 22, frame 23) have a second focal plane FP2, and frames in a third row (frame 31, frame 32, frame 33) have a third focal plane FP3. Frames in a first column (frame 11, frame 21, frame 31) have a first value AP1, frames in a second column (frame 12, frame 22, frame 32) have a second value AP2, and frames in a third column (frame 13, frame 23, frame 33) have a third value AP3 of another parameter. Then, frames arranged along a sloping line in the matrix, which are frame 11, frame 22, and frame 33 encompassed by a dashed line in FIG. 6, are selected. Then, clear portions of these three frames, that is, portions on the first focal plane FP1 of frame 11, portions on the second focal plane FP2 of frame 22, and portions on the third focal plane FP3 of frame 33, may be extracted by employing multi-frame processing algorithms and combined to form a clear picture with all portions of the picture fully focused so as to achieve EDOF enhancement.

In another embodiment, the method 200 may be used for soft focus enhancement. The difference between this embodiment and the previous embodiment is that after frame 11, frame 22, and frame 33 are selected, multi-frame processing algorithms may be employed to separate backgrounds from foregrounds of frame 11, frame 22, and frame 33, and to blur the separated backgrounds. Then, foregrounds and blurred backgrounds are combined to form a picture with a clear foreground and a blurred background so as to achieve soft focus enhancement.

In another embodiment, the method 200 may be used for multi-frame background change enhancement. The difference between this embodiment and the previous embodiment is that after frame 11, frame 22, and frame 33 are selected, multi-frame processing algorithms may be employed to separate backgrounds from foregrounds of frame 11, frame 22, and frame 33, and to replace the separated backgrounds with predetermined backgrounds. Then foregrounds and predetermined backgrounds may be combined to form a picture having a foreground and a predetermined background.

In yet another embodiment, the method 200 may be used for portrait focus enhancement. In such case, multi-frame processing algorithms may be employed to separate portraits in foregrounds from backgrounds of frame 11, frame 22, and frame 33, and to replace the separated portraits with portraits on focus. Then portraits on focus and backgrounds may be combined to form a picture with a portrait on focus and a background.

In still another embodiment, the method 200 may be used for multi-frame sim3D (multi-frame 3D simulation) enhancement. The difference between this embodiment and the previous embodiment is that after frame 11, frame 22, and frame 33 are selected, multi-frame processing algorithms may be employed to manipulate portions on the first focal plane FP1 of frame 11, portions on the second focal plane FP2 of frame 22, and portions on the third focal plane FP3 of frame 33 with a first depth value, a second depth value, and a third depth value respectively. Then, these manipulated portions may be combined to form a 3D picture.

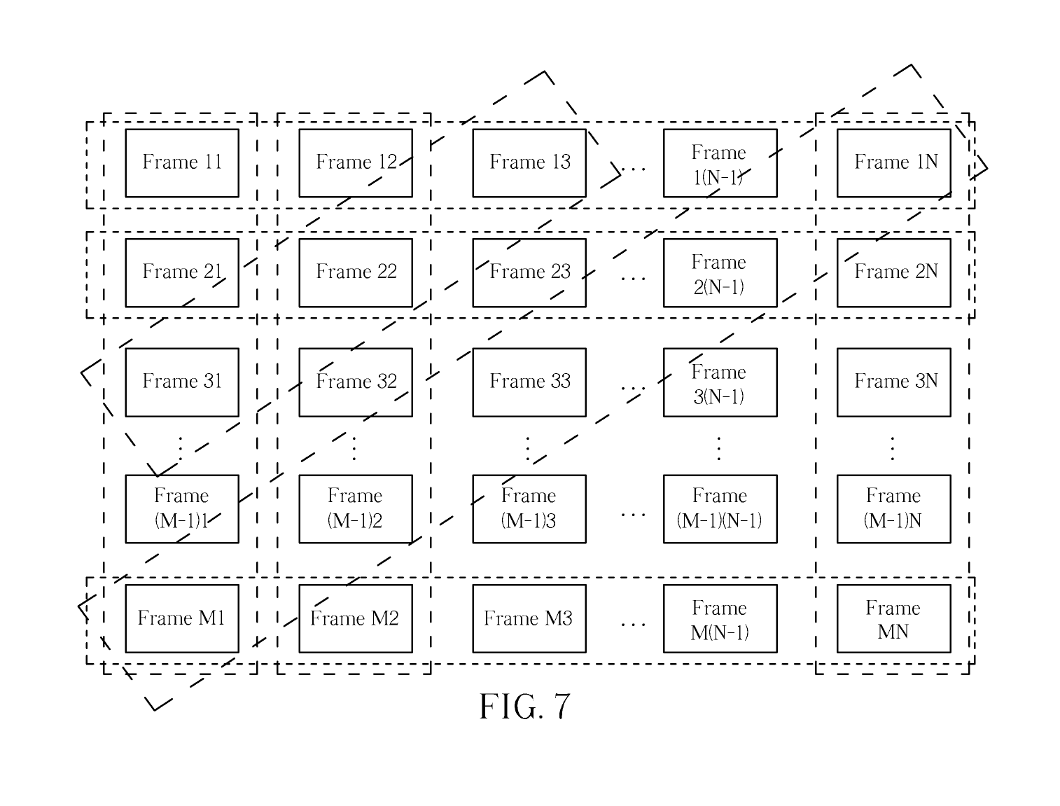

FIG. 7 illustrates other embodiments of methods 100 and 200 according to FIGS. 1 and 2, and embodiments of the present invention are not limited thereto. The matrix 700 is an M*N matrix where M and N are integers greater than 1. Frames in a same row of the matrix 700 may have at least one identical parameter value and frames in a same column of the matrix 700 may also have at least one identical parameter value. In step 106 or step 206, the set of frames may be selected from a row, a column, along a sloping line in the matrix, as shown by dashed lines of the matrix 700, or other ways without limitation thereto. Any number of frames in a row, in a column, or along a sloping line is allowed to be selected. Even all frames in the matrix 700 may also be selected according to methods 100 or 200.

In summary, the present invention provide a method for enhancing quality of pictures to produce clear pictures or achieve other kinds of picture effects according to users' requirements.

Those skilled in the art will readily observe that numerous modifications and alterations of the device and method may be made while retaining the teachings of the invention. Accordingly, the above disclosure should be construed as limited only by the metes and bounds of the appended claims.

1. A method for forming at least one picture comprising:
continuously capturing an image to generate a plurality of frames according to a plurality of parameters;
arranging the plurality of frames in a matrix according to values of the plurality of parameters, wherein frames in a same row of the matrix have first parameters of a same value and second parameters of different values, and frames in a same column of the matrix have first parameters of different values and second parameters of a same value;
selecting a set of frames from the matrix;
extracting portions of the set of frames; and
combining the portions to form at least one picture.

2-3. (canceled)

4. The method of claim 1 wherein the matrix is an M*N matrix where M and N are integers greater than 1.

5. The method of claim 1 wherein the set of frames is selected from a row in the matrix.

6. The method of claim 1 wherein the set of frames is selected from a column in the matrix.

7. The method of claim 1 wherein the set of frames is selected along a sloping line in the matrix.

8-9. (canceled)

10. The method of claim 1 wherein continuously capturing the image to generate the plurality of frames is a digital camera continuously capturing the image in rapid succession to generate the plurality of frames.

11. A method for forming at least one picture comprising:
continuously capturing an image to generate a plurality of frames according to a plurality of parameters;
arranging the plurality of frames in a matrix according to values of the plurality of parameters, wherein frames in a same row of the matrix have first parameters of a same value and second parameters of different values, and frames in a same column of the matrix have first parameters of different values and second parameters of a same value;
selecting a set of frames from the matrix;
processing the set of frames with multi-frame processing algorithms to generate a plurality of processed frames; and
forming at least one picture from the plurality of processed frames.

12-13. (canceled)

14. The method of claim 1 wherein the matrix is an M*N matrix where M and N are integers greater than 1.

15. The method of claim 11 wherein the set of frames is selected from a row in the matrix.

16. The method of claim 11 wherein the set of frames is selected from a column in the matrix.

17. The method of claim 11 wherein the set of frames is selected along a sloping line in the matrix.

18-19. (canceled)

20. The method of claim 11 wherein continuously capturing the image to generate the plurality of frames is a digital camera continuously capturing the image in rapid succession to generate the plurality of frames.
